(19) United States
(12) Patent Application Publication
(10) Pub. No.: US 2008/0248261 A1
(43) Pub. Date: Oct. 9, 2008

(54) PRINTED ARTICLE

(76) Inventors: Robert A. Bonnett, San Diego, CA (US); Betty A. Coulman, Corvallis, OR (US); Barbara Baxter, Corvallis, OR (US); Leo C. Clarke, Albany, OR (US); Susan Williams, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/697,178

(22) Filed: Apr. 5, 2007

(51) Int. Cl. B41M 5/00; B32B 37/00; B32B 27/40

(52) U.S. Cl. 428/195.1; 156/250; 156/280; 428/423.1

(57) ABSTRACT

An article having a printed image is formed from a substrate, an adhesive disposed over the substrate, a sheet disposed over the adhesive, a digitally printed image directly printed on the sheet, and an elastomer disposed over the printed image.

### BACKGROUND

Graphics, including text for advertisement, personalization, branding, or other identifications may be included on sports equipment. Graphics may also be included on other surfaces. It can be difficult and costly to apply graphics to pre-formed shapes of fully formed articles, such as the curves associated with sports equipment. Decals, stickers, or the like, which can include graphics, may conform to the pre-formed shapes; however decals are often not durable and can be scraped away during use, especially on sports equipment.

Set-up time and cost for the graphics may be significant. Once a graphic has been set-up, applying the graphic to a large number of items lowers the per-unit cost of the item. Hence, graphic jobs with a relatively high number of marked items may offer a relatively low per-unit cost, despite a high set-up cost; however, customization and uniqueness of graphics is lost when applied to a relatively large number items.

Personalized graphics, customized graphics, repair of existing graphics, and promotional advertising campaign surveys are some examples where relatively small batches of items or surfaces may be marked. Customized screen printing has attempted to lower the per-unit cost of graphics on articles having relatively small batches. However, customized screen printing may take a long time to set up, may suffer from a reduced color gamut and reduced image resolution. Screen printing may also lack durability, suffer from process inconsistencies resulting in variable quality, and present alignment difficulties, especially when applied to preformed shapes.

There is demand for high quality durable full gamut color graphics to be applied to a single or a limited number of articles in a low cost, timely manner. The articles may have curves and shapes.

### BRIEF DESCRIPTION OF THE DRAWINGS

FIG. 1A shows a cross sectional view of a printed article with a printed image above a sheet of media and an overcoat above the printed image according to an embodiment of a printing system.

FIG. 1B illustrates a cross sectional view of a printed article with a printed image below a sheet of media and a overcoat above the sheet of media according to an embodiment of a printing system.

FIG. 1C illustrates a cross sectional view of the printed article in FIG. 1B with the overcoat applied to sides of a sheet of media.

FIG. 1D shows another cross sectional view of a printed article without an overcoat according to an embodiment of a printing system.

FIG. 1E illustrates a sheet of media with channels and an adhesive with channels according to an embodiment of a printing system.

FIG. 2A shows a skateboard as an exemplary embodiment of a printed article according to an embodiment of a printing system.

FIG. 2B shows a snowboard as an exemplary embodiment of a printed article according to an embodiment of a printing system.

FIG. 2C shows a surfboard as an exemplary embodiment of a printed article according to an embodiment of a printing system.

FIG. 3A illustrates a guitar as an exemplary embodiment of a printed article according to an embodiment of a printing system.

FIG. 3B illustrates a drum set as an exemplary embodiment of a printed article according to an embodiment of a printing system.

FIG. 3C illustrates a keyboard set as an exemplary embodiment of a printed article according to an embodiment of a printing system.

FIG. 4A shows a semi-truck and trailer as an exemplary embodiment of a printed article according to an embodiment of a printing system.

FIG. 4B shows an automobile as an exemplary embodiment of a printed article according to an embodiment of a printing system.

FIG. 4C shows a boat as an exemplary embodiment of a printed article according to an embodiment of a printing system.

FIG. 4D shows a motorcycle as an exemplary embodiment of a printed article according to an embodiment of a printing system.

FIG. 5 illustrates signs as exemplary embodiments of printed articles according to an embodiment of a printing system.

FIG. 6 shows a flowchart for applying a print to an article according to an embodiment of a printing system.

### DETAILED DESCRIPTION

In the present application, an embodiment of a printed article relates to a printed image on the surface of an article. The printed article may be, but is not limited to a sports board. The sports board may be a skate board, a snow board, a surf board, a bodyboard, a wakeboard, a snow ski, or the like. Other examples of printed articles are described in the present application.

There has been a long felt but unsolved ability of others to produce a low cost, customizable, high resolution, full gamut color graphic, having a durable surface. This useful graphic may be applied to pieces of sports equipment or other articles to customize the articles, show group identity, or the like.

During development, the applicants extensively experimented with coatings, sheets of media, and inks on pieces of sports equipment such as skateboards and snowboards. The result of the experimentation is a combination of compatible materials which provide a low cost, customizable, high resolution, full gamut color graphic. The graphic can be applied to a variety of articles. The articles include, but are not limited to, sports equipment.

During experimentation, coatings such as lacquer were too brittle, yellowed, and lacked toughness. Some sheets of media lacked flexibility and did not conform to the shapes and curves of a skateboard or a snowboard. Some coatings caused the ink to run, bleed, and smear. The applicants have discovered a unique combination of compatible media, ink, and overcoats which enables low cost, customized high quality graphics to be applied to preformed articles, such as sports equipment.

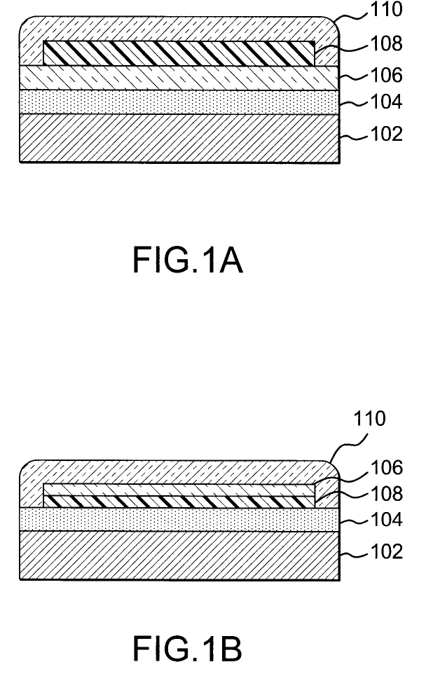

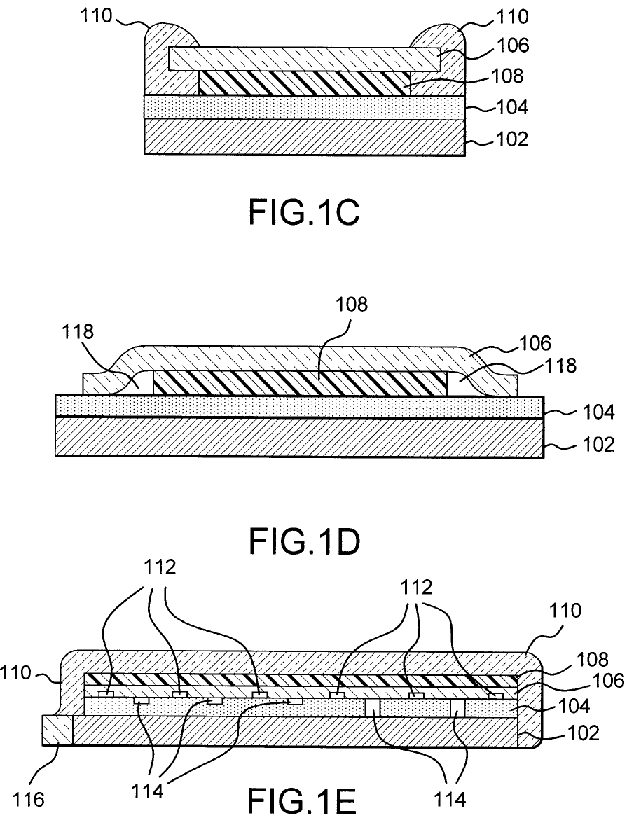

One embodiment of a printed article is shown in FIG. 1A. An adhesive 104 is disposed over a substrate 102; a sheet of media 106, such as print medium, is disposed over the adhesive 104; a printed image 108, such as a digitally printed image, is printed on the sheet of media 106; and an overcoat 110, such as an elastomer, is disposed over the printed image 108. The elastomer may also be disposed over the adhesive 106.

Another embodiment of a printed article is shown in FIG. 1B. An adhesive 104 is over a substrates 102; a printed image 108 is over the adhesive 104; a sheet of media 106 is over the printed image 108; and an overcoat 110 is over the sheet of media 106, the printed image 108, and the adhesive 104.

Another embodiment of a printed article is shown in FIG. 1C. FIG. 1C has similar layers to FIG. 1B, however the overcoat is not applied over the central portion of the sheet of media.

Another embodiment of a printed article is shown in FIG. 1D. An adhesive 104 is over a substrate 102; a printed image 108 is over the adhesive 104; and a sheet of media 106 is over the printed image 108.

Another embodiment of a printed article is shown in FIG. 1E. An edge 116 is attached to a substrate 102, an adhesive 104 is over the substrate 102, a sheet of media 106 is over the adhesive 104, a printed image 108 is over the sheet of media 106, and an overcoat 110 is over the printed image 108, the sheet of media 106, the adhesive 104, the edge 116 and the substrate 102.

In the embodiments of a printed article described above, the printed image may be removed or repaired by cutting or peeling away the overcoat 110 and prying the sheet of media 106 away from the adhesive 104.

FIG. 1A shows a cross sectional view of a printed article with a printed image 108 above a sheet of media 106 and an overcoat 110 over the printed image 108 and the sheet of media 106 according to an embodiment of a printing system. The overcoat 110 may be transparent to allow the printed image 108 to be visible through the overcoat 110. An adhesive 104 is over a substrate 102. Prior to applying the adhesive 104 to the substrate 102 or the sheet of media 106 or both, the substrate 102 or sheet of media may be coated with an adhesion promoting primer such as a silane coupling agent. Other adhesion promoting primers may be used.

The adhesive 104 may be a thermoplastic or thermosetting elastomer or another similar material, such as, but not limited to, acetate, acrylic, urethane, silicone, or polyamide. The adhesive 104 may remain flexible to permit adjustment of the sheet of media 106 relative to the substrate 102. The adhesive 104 may be cured by solvent evaporation, ultraviolet, thermal, or other types of radiation. Alternately, the adhesive 104 may remain uncured, facilitating removal of the sheet of media 106 for repair or change of the printed image 108. The printed image 108 may be removed or repaired by cutting or peeling away the overcoat 110 and prying the sheet of media 106 away from the adhesive 104, or the adhesive 104 away from the substrate 102 or both.

The adhesive 104 may be a pressure sensitive adhesive such as: acetate, acrylic, urethane, silicone, polyamide, or the like. If the adhesive 104 is a liquid or a gel, the adhesive 104 may be applied to the substrate 102, the sheet of media 106, or both by rolling, brushing, spraying, dipping, gravure printing, ink-jet printing, by a squeegee, or by another method. If the adhesive 104 is semi-solid, the adhesive 104 may be applied to the substrate 102 or the sheet of media 106 by laminating, or the like. The adhesive 104 may be a pressure sensitive adhesive. The adhesive 104 may be covered with a protective film which may be removed prior to use.

The substrate 102 may be a material such as, but not limited to: wood, laminate, metal, plastic, glass, fiberglass, carbon fiber, other fibrous materials, or combinations thereof. The substrate 102 may be a pre-formed shape such as a fully formed article or a fully formed piece of sports equipment. A fully formed article is defined as an article which has functionality without another step or process. An example of a fully formed article is a skateboard blank. The skateboard blank is functional, with the shapes and curves enabling flex and board position of the skateboarder on the skateboard. A full gamut color graphic, including text may be applied to the skateboard blank to customize the skateboard as described in the present application.

The sheet of media 106 is over the adhesive 104. In some embodiments, the sheet of media 106 may conform to the shape of the substrate 102. A vinyl sheet may be used as a sheet of media 106 for conforming to the shaped substrate 102; however, the sheet of media 106 is not limited to vinyl. Another sheet of media 106 may be used, such as a transparency film (used for projectors), a photo paper, or the like. However, a transparency film or a photo paper may not conform to the shapes or curves of a sports board or another article. The sheet of media 106 may be embossed to provide optical effects such as a diffraction grating.

The printed image 108 may be applied to the sheet of media 106 before the sheet of media 106 is applied to the adhesive 104. The sheet of media 106 can serve as a base for the printed image 108 and have properties allowing ink, toner, wax, or another suitable colorant to bind to the sheet of media 106 and not run, bleed, streak, or the like. The sheet of media 106 may be coated. The coating may improve the quality of the printed image 108 on the sheet of media 106 by limiting the amount of running, bleeding, streaking, colorant mixing, or the like.

A printed image 108 is over the sheet of media 106. The printed image 108 may be printed on a sheet of media 106 prior to the sheet of media 106 being adhered to the substrate 102 with the adhesive 104. The printed image 108 may also be printed on an adhesive backed sheet of media 106 prior to being placed on the substrate 102. The printed image 108 may be digitally printed using ink-jet, laser, wax, thermal transfer, or other types of printing. The printed image 108 may include full gamut color graphics and text, and be ultraviolet resistant. The printed image 108 may respond to ultraviolet or visible illumination. For instance, colors in the printed image 108 may fluoresce or be enhanced by the presence of ultraviolet radiation. The printed image 108 may include marks to verify authenticity, such as: a unique owner identification, a digitally enhanced embedded image, or the like.

The sheet of media 106 may be fixed to the adhesive 104 using a laminator, a press, a roller, pressure, vacuum, or any other method which may press on either the printed image 108 or the sheet of media 106. The printed image 108 may be printed on the sheet of media 106 before or after the sheet of media 106 is adhered to the substrate 102. In FIG. 1A, the printed image 108 is printed on the sheet of media 106 opposite to the adhesive 104.

An overcoat 110 is over the printed image 108. An adhesion promoter such as a silane coupling agent may be applied to the printed image 108 before applying an overcoat 110. If the overcoat 110 is liquid, the overcoat 110 may be applied by spraying, rolling, brushing, by a squeegee, gravure printing, ink-jet printing or another method. If the overcoat 110 is semi-solid, the overcoat 110 may be applied by lamination or other methods. The overcoat 110 can seal and protect the printed image 108, including the side of the printed image 108. The overcoat can contact the sheet of media 106. The overcoat 110 may be substantially transparent in some areas and not in other areas. The overcoat 110 is compatible with the printed image 108, such that the text or printed image 108 does not bleed, streak, run, or suffer other types of defects. The overcoat 110 may be chosen to be tough, flexible, impact resistant, abrasion resistant, scratch resistant, cut resistant, wear resistant, tear resistant, water resistant, or the like. An aliphatic urethane, when used as an overcoat 110, can exhibit the aforementioned properties. An epoxy can also be used as an overcoat 110 with 10% to 80% toughener by weight, such as silicone to exhibit the aforementioned properties.

In certain embodiments, the overcoat 110 may have a glass transition temperature of about minus 40 to minus 20 degrees Celsius, the temperature where the overcoat 110 may become brittle and crack at lower temperatures. The cold crack resistance of the overcoat 110 may be minus 20 degrees Celsius.

The overcoat 110 may remain flexible. The flexible modulus of the overcoat 110 may range from 200 to 500 million Pascals according to ASTM standard testing method D790. The overcoat 110 may have a Young's modulus ranging from 20 to 500 million Pascals.

The overcoat 110 may be resistant to impact. The impact resistance of the overcoat 110 may be 213 Joules per meter or greater according to ASTM standard testing method D256.

The overcoat 110 may be resistant to cutting and may have a cut resistance ranging from 1 to 3 on a scale of 1 to 6.

The printed image 108 may be visible through the overcoat 110. The transparency of the overcoat 110 may be from about 80 percent to 100 percent for the colors of red, green, and blue color bands. However, the overcoat 110 may have selective areas which are not transparent. These areas may contain additives which alter the optical properties of the overcoat 110. The additives may tint, color, or cause the overcoat 110 to become selectively opaque, reflective, fluorescing, or the like. The overcoat 110 may respond to ultraviolet or visible light by retransmitting light at particular wavelengths in response to illumination. The overcoat 110 may be nano-embossed to alter the visible properties of light, such as, for example, to change the color by diffraction. The overcoat 110 is not limited to the examples provided.

Unique identifiers such as holograms, watermarks, logos, or the like may be applied below or in the overcoat 110 for the purpose of providing authenticity or brand recognition. Other unique identifiers such as a person's name, an organization's name, or other identifiers may be included in the overcoat 110 to aid identification or deter theft.

The overcoat 110 can expand or be compressed significantly without structural damage. The overcoat 110 may elongate or compress from 10 percent to 45 percent from the original length without damage.

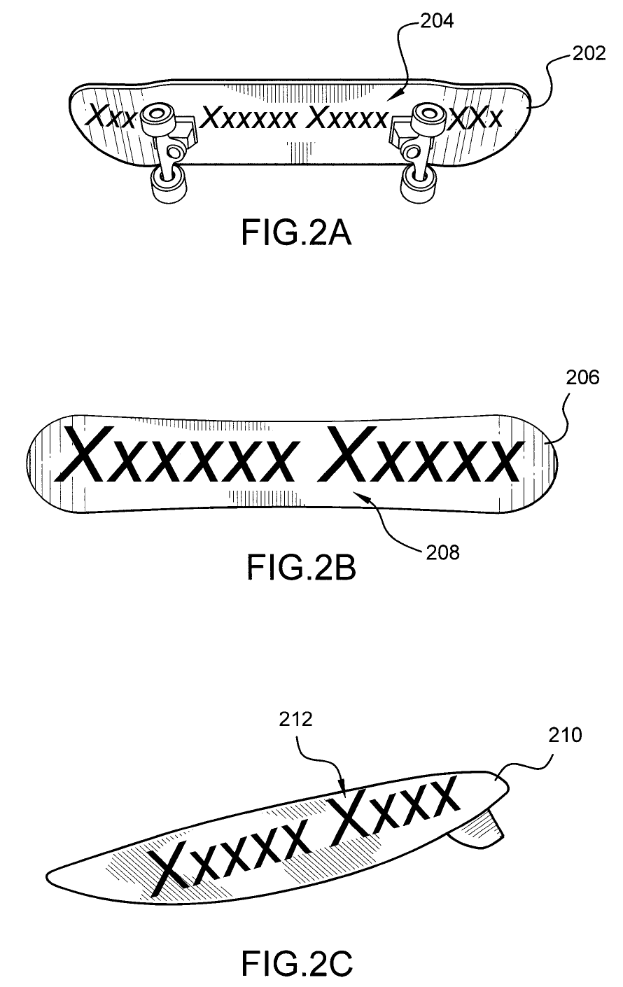

In certain applications of printable articles, such as a skateboard 202 (see FIG. 2A), it may be important to control the sliding frictional coefficient of the overcoat 110, such as when the skateboard is sliding on a rail. A sliding frictional coefficient may be from about 0.2 to 0.6. If the frictional coefficient of the overcoat 110 is too low, then when the overcoat 110 of a skateboard 202 contacts a rail, the skateboard 202 may slip off. If the frictional coefficient is too high, then the skateboard may stick to the rail. If the sliding frictional coefficient of the overcoat 110 is too low, then the sliding frictional coefficient may be increased by adding friction enhancing filler particles to the overcoat 110. Friction enhancing filler materials may include carbides, silicon, glass, sand, flint, or the like. If the sliding frictional coefficient of the overcoat 110 is too low, then the sliding frictional coefficient may be decreased by adding friction reducing filler particles to the overcoat 110. Friction reducing filler materials may include a polytetrafluoroethylene—PTFE. The coefficient of friction of the overcoat 110 may be tuned by adding frictional filler particles to the overcoat 110. Tuned means modified, changed, adjusted or the like.

The overcoat 110 may be an aliphatic elastomer. However, the overcoat 110 may also be chosen from the following list of compounds: a monomeric, oligomeric or prepolymeric precursor of vinyl resins; a polyolefin; a polyurea; a polyamide; a polyamide/polyurethane copolymer; a polyamide/polyurea copolymer; an epoxy-end-capped polyurethane; an epoxy-end-capped polyurea; a polyamide and polyurethane ionomer; a polyamide and a polyurea ionomer; an acrylic resin; an olefinic rubber; a polyphenylene oxide resin; a polyester; a blend of vulcanized, unvulcanized or non-vulcanizable rubber with polyethylene, polypropylene, polyacetal, nylon, polyester, or cellulose esters; or a polymer or copolymer possessing epoxy; or post-polymerization epoxy-functionalized repeat units. The overcoat 110 may be an epoxy filled with 10 percent to 80 percent toughener such as silicone. The overcoat 110, the adhesive 104, or both may be cured, cross-linked, or set by thermal, ultraviolet, chemical, solvent evaporation or other methods.

FIG. 1B illustrates a cross sectional view of a printed article with a printed image 108 below a sheet of media 106 and an overcoat 110 above the sheet of media 106 according to an embodiment of a printing system. An adhesive 104 is over a substrate 102. The adhesive 104 may be a thermoplastic or thermosetting elastomer or the like. If the adhesive 104 is a liquid or a gel, the adhesive 104 may be applied to the substrate 102 or the printed sheet of media 106, or both by rolling, brushing, spraying, dipping or the like. If the adhesive 104 is semi-solid, the adhesive 104 may be applied to the substrate 102 or the printed sheet of media 106, or both by laminating or by another method.

The substrate 102 may be a material such as, but not limited to, wood, laminate, metal, plastic, glass, fiberglass, carbon fiber, other fibrous materials, or combinations thereof.

A printed image 108 may be digitally printed to a substantially transparent sheet of media 106 using ink-jet, laser, wax, thermal transfer or other types of printing. The printed image 108 may include text. The sheet of media 106 may be, but is not limited to, a vinyl sheet. For example, the sheet of media 106 may be an overhead transparency sheet.

The printed image 108 may be in direct contact with the adhesive 104. The contact may occur by pressing down on the sheet of media 106 with a laminator, a press, a roller, or another method to sandwich the printed image 108 between the sheet of media 106 and the adhesive 104 such as vacuum or pressure. The adhesive 104 and the printed image 108 are formulated so that the printed image 108 does not bleed, streak, run, blister, or suffer other types of defects when contacting the adhesive 104.

An overcoat 110 covers the sheet of media 106 and the printed image 108. The overcoat 110 seals the sides of the printed image 108 to protect the printed image 108 from moisture or other contaminants. Alternately, as shown in FIG. 1C, the overcoat 110 may cover the sides of the sheet of media 106 and the printed image 108 where the central portion of the sheet of media 106 does not have an overcoat 110 and the sheet of media 106 protects the printed image 108. The overcoat 110 may be tough to withstand impact, abrasion, or the like. The overcoat 110 may be an aliphatic elastomer. However, the overcoat 110 may also be chosen from the compounds listed above in reference to FIG. 1A.

FIG. 1C illustrates a cross sectional view of the printed article in FIG. 1B with the overcoat applied to sides of a sheet of media 106. The sheet of media 106 protects the printed image 108 in the center, and the overcoat 110 protects the printed image along a side.

FIG. 1D illustrates another cross sectional view of a printed article without an overcoat 110 according to an embodiment of a printing system. An adhesive 104 is over a substrate 102. The adhesive 104 may be a thermoplastic or thermosetting elastomer or the like. If the adhesive 104 is a liquid or a gel, the adhesive 104 may be applied to the substrate 102 or the printed sheet of media 106, or both by rolling, brushing, spraying, dipping or the like. If the adhesive 104 is semi-solid, the adhesive 104 may be applied to the substrate 102 or the printed sheet of media 106, or both by laminating or by another method.

The substrate 102 may be a material such as, but not limited to, wood, laminate, metal, plastic, glass, fiberglass, carbon fiber, other fibrous materials, or combinations thereof.

A digitally printed image 108 may be applied to a substantially transparent sheet of media 106 using ink-jet, laser, wax, thermal transfer or other types of printing. The printed image 108 may include text. The printed image 108 may be a digital image, and may be applied directly to a central portion of the sheet of media 106. The sheet of media 106 may be, but is not limited to, a vinyl sheet.

The printed image 108 may be in direct contact to the adhesive 104. The contact may occur by pressing down on the sheet of media 106 with a laminator, a press, a roller, or another method to sandwich the printed image 108 between the sheet of media 106 and the adhesive 104. The adhesive 104 and the printed image 108 are formulated such that the printed image 108 does not significantly bleed, streak, run, blister, or suffer other types of defects when contacting the adhesive 104. Sides of the sheet of media 106 may extend past the side of the printed image 108. The side of the sheet of media 106 around the perimeter of the sheet of media 106 can contact the adhesive 104. The contact seals and protects the printed image 108.

There may be a void 118 formed between the printed image 108, the adhesive 104, and the sheet of media 106. The void may be filled with a material.

FIG. 1E illustrates a sheet of media 106 with media channels 112 and an adhesive 104 with adhesive channels 114 according to an embodiment of a printing system. The sheet of media 106 may have one or more media channels 112. When the sheet of media 106 is placed on the adhesive 104, the one or more media channels 112 may allow air to vent from between the sheet of media 106 and the adhesive 104 thereby reducing entrapped air. Entrapped air may occur when an outer portion of the sheet of media 106 contacts the adhesive 104 before a central portion of the sheet of media 106 contacts the adhesive 104. The entrapped air may form blisters or bubbles.

The adhesive 104 may have adhesive channels 114. The adhesive channels 114 may allow entrapped air between the adhesive 104 and the sheet of media 106 to vent, thereby reducing the entrapped air between the sheet of media 106 and the adhesive 104. The adhesive channels 114 may extend partially or completely through the height of the adhesive 104.

The overcoat 110, such as an elastomer, may contact the substrate 102, the adhesive 104, the sheet of media 106, and the printed image 108. The overcoat 110 may form a seal or a bumper, or both to protect the sides of the substrate 102, the adhesive 104, the sheet of media 106, and the printed image 108. An edge 116 may be attached to the substrate 102. The edge 116 may be a metal edge of a snowboard or a snow ski, or it may be a durable material such as rubber. The edge 116 may protect the substrate 102 and the sides of the sheet of media 106 and the printed image from impact. The edge 116 may be attached to the substrate 102. The edge 116 may be coated with an overcoat 110. Although not shown in FIG. 1E, the edge 116 may also contact the adhesive 104, the sheet of media 106, and the printed image 108.

The printed image 108 may be printed above the sheet of media 106 as shown in FIG. 1A, below the sheet of media 106 as shown in FIG. 1B, or both above and below the sheet of media 106 to give viewing angle dependent effects such as a three dimensional appearance.

FIG. 2A shows a skateboard as an exemplary embodiment of a printed article according to an embodiment of a printing system. The graphic 204 may be applied as layers as shown in FIGS. 1A-E. In FIGS. 1A, B and E, an overcoat 110 can give the graphic the virtues of being tough, flexible, impact resistant, abrasion resistant, cut resistant, water resistant, and ultraviolet resistant as described in reference to FIG. 1A. The graphic 204 is shown applied to the bottom side of the skateboard; however, the graphic 204 may also be applied to the top side of the skateboard (not shown). The graphic 204, when applied to the top side of the skateboard (not shown), may include friction enhancing filler particles in the overcoat 110 (see FIGS. 1A, 1B, and 1E) so that a skateboarder may better grip the board. The graphic 204 may include a promotional, team, specialty, or another type of graphic which may be quickly changed or re-applied. The graphic 204 may be printed with ink-jet or another type of digital printing to give photographic quality with a full gamut of colors.

Color alignment may be difficult to achieve and result in printed image quality problems when using screen printing, especially when the article has shapes and curves. Printing on a sheet of media 106 (see FIGS. 1A-E) with ink-jet or other types of printing can avoid these problems. The sheet of media 106 may be vinyl, which can conform to the shapes and curves of a skateboard 202.

FIG. 2B shows a snowboard as an exemplary embodiment of a printed article according to an embodiment of a printing system. A full gamut color graphic 208 as shown and described in reference to FIGS. 1A-E, may be applied to a snowboard 206 as shown in FIG. 2B. The flexibility, toughness, cold crack resistance, and water resistance of the full gamut color graphics shown and described in reference to FIGS. 1A-E provides particular utility for a snowboard. Custom graphics can be applied to the snowboard to provide a new look. The graphic may be individually illustrated for a one-of-a-kind look. The full gamut color graphic may also be a photograph. An original or replicated autograph may be included with, or separate from, the photograph. As shown and described in reference to FIGS. 1A-E, custom, low cost, full gamut color graphics may be rendered and applied to the snowboard.

FIG. 2C shows a surfboard as an exemplary embodiment of a printed article according to an embodiment of a printing system. A full gamut color graphic 212 as shown and described in reference to FIGS. 1A-E may be applied to a surfboard 206 as shown in FIG. 2B. The flexibility, toughness, water resistance, and ultraviolet resistance of the graphic shown and described in reference to FIGS. 1A-E provide particular utility for a surfboard. Furthermore, friction enhancing filler materials such as carbides, silicon, glass, flint, sand or the like may be added to the overcoat 110 as referenced in FIGS. 1A, 1B and 1E to provide grip to the surfboard.

Although embodiments for printable articles have been shown for a skateboard 202 in FIG. 2A, a snowboard 206 in FIG. 2B, and a surfboard 210 in FIG. 2C, other types of sports equipment may also have full gamut color graphics printed on them. Examples, include, but are not limited to: a wakeboard, a bodyboard, a golf club, a water ski, a tennis racquet, a snow ski, a baseball bat, a helmet, a hockey stick, a throwable disk, shoes, or a skate.

The sports equipment illustrated in FIG. 2A through 2C and the examples of sports equipment listed above are configured to be in contact with a person during normal operation of the article. Contact is defined as actual physical contact with of the person or contact with the person through clothing or apparel. For instance, when boarding, a boarder stands on a skateboard, a snowboard or a surfboard; however, the boarder may be wearing shoes, boots, or insulating booties respectively and still be in contact with the sports equipment. When skiing, a skier stands on a ski; however the skier may contact the ski through a binding and a boot. When golfing, a golfer grips a golf club; when batting, a batter grips a bat; when playing tennis, a tennis player grips the racquet, when playing hockey, a player grips a hockey stick, when throwing a disc, an ultimate player or a disc golf player grips a disk. In each of these examples, the person may be wearing a glove. The person still contacts the sports equipment through the glove. Customized sports equipment which is in contact with the user during normal operation of the article may establish the identity of a user and a team. One such example is a football helmet. The team identity may be useful in establishing brand recognition, marketing presence, advertising, or the like. Another example may be a graphic on a shoe. An individual identity graphic can enable the user to identify their own helmet.

It may be cost prohibitive or otherwise impractical to have skateboards, snowboards, surfboards, or other sports equipment graphically customized for a user or team. Yet there is a demand for cost effective custom labeled sports equipment. Fully formed articles of sports equipment may be fully formed pieces of sports equipments such as skateboard blanks, golf clubs, or the like, which may be purchased for substantially less cost than a limited run of custom labeled sports equipment of similar quality. Custom graphics applied to fully formed articles of sports equipment may amount to screened paint on the fully formed articles. The screened paint may quickly rub or scrape off during normal use. However, in accordance with the present application, custom full gamut color graphics can be applied to the fully formed articles of sports equipment using digital printing. Digital printing allows a single, customizable, full gamut color graphic to be created for a relatively small amount of money as contrasted with a relatively large sum of money to set up and use print screens. As disclosed in the present application, the custom, full gamut color graphic also has a durable overcoat, which makes the graphic less likely to rub or scrape off during use.

Embodiments for a customizable, cost effective, high resolution, durable full gamut color graphic, which are applied to fully formed sports equipment are described herein in embodiments of a printing system. For instance, the sheet of media 106 (see FIG. 1A-E) which may be vinyl, conforms to a fully formed shape of an article of sporting equipment, such as a skateboard, snowboard, or a surfboard as shown in FIGS. 2A-C. The overcoat 110 (see FIGS. 1A, 1B, and 1E) is durable, abrasion resistant, and water resistant. The printed image 108 retains a high spatial resolution; unlike screen printing and sublimation transfers. Screen printing is limited to the resolution of the screen, and may be jagged on the trailing portion of the squeegee when the print is screened. Sublimation can limit the spatial resolution of the image during transfer, because the sublimation can diffuse laterally when the dye is sublimated to a substantial depth in the surface.

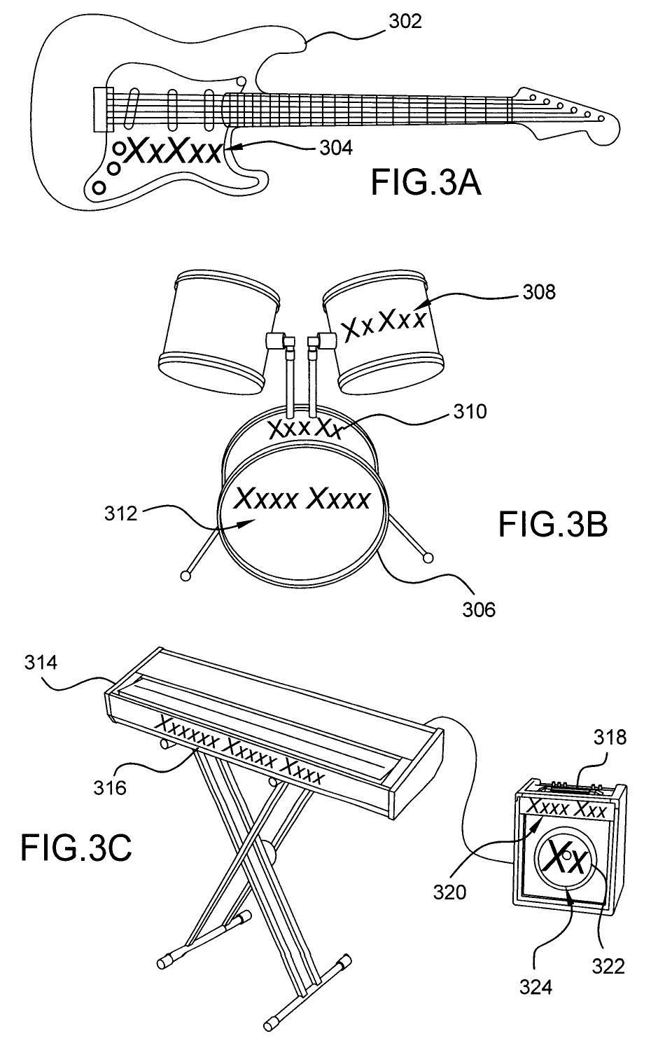

FIG. 3A illustrates a guitar as an exemplary embodiment of a printed article according to an embodiment of a printing system. A full gamut color graphic 304 as referred to in FIGS. 1A-E may be applied to a guitar 302. The abrasion resistance of the graphic shown and described in reference to FIGS. 1A, B and E can be useful to protect the guitar from damage from picks, fingernails, jewelry or other objects. The full gamut color graphic may include an illuminating ink in the printed image 108, such as an ultraviolet fluorescing ink, to enhance graphic effects. The overcoat 110 may include fluorescing agents, light reflective particles, such as glitter, or the like to enhance graphic effects.

FIG. 3B illustrates a drum set as an exemplary embodiment of a printed article according to an embodiment of a printing system. A full gamut color graphic 308, 310 or 312 or combinations thereof, as referred to in FIGS. 1A-E, may be applied to a drum set 306. The flexibility of the graphic as described in reference to FIGS. 1A-E provides usefulness for the graphic 312 when applied to a surface of a bass drum of the drum set 306. Since, when played, the bass drum has significant vibration, the flexibility of the graphic 312 may adhere to the drum surface without cracking or peeling.

FIG. 3C illustrates a keyboard set as an exemplary embodiment of a printed article according to an embodiment of a printing system. A keyboard 314 may be custom labeled with a full gamut color graphic 316 as referred to in FIGS. 1A-D, for example, to signify the name of an artist, a band, a manufacturer, a distributor, or the like. Similarly, an amplifier head 318 for a speaker 322 may be labeled with a full gamut color graphic 320. A full gamut color graphic 324 may be directly labeled on the speaker 322. In operation, the graphic 324, since flexible, may not crack nor peel and can adhere to, and move with, the speaker 322.

Although embodiments for printable articles have been shown for a guitar 302 in FIG. 3A, a drum set 206 in FIG. 3B, and a keyboard 314, head 318, and a speaker 322 in FIG. 3C, other types of musical instruments including the cases for musical instruments, or articles of entertainment, or articles of business may also have graphics on them. Examples, include, but are not limited to: a piano, a violin, a cello, a tuba, a French horn, a trombone, a tambourine, and cases for musical instruments. Business and entertainment equipment includes, a computer, a stereo, a display, a monitor, a personal digital assistant, personal music equipment, cell phones, personal video players, or the like. Transportation cases for the business and entertainment equipment may also have full gamut color graphics on them.

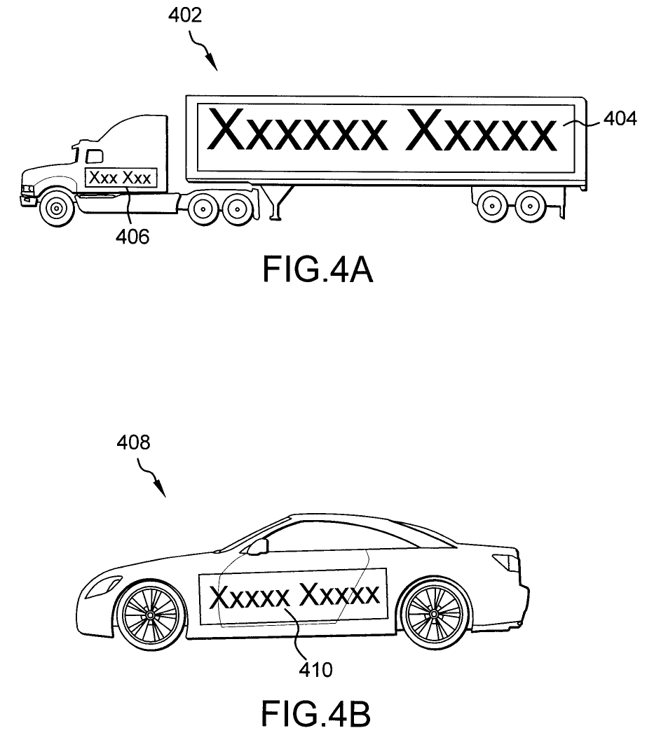

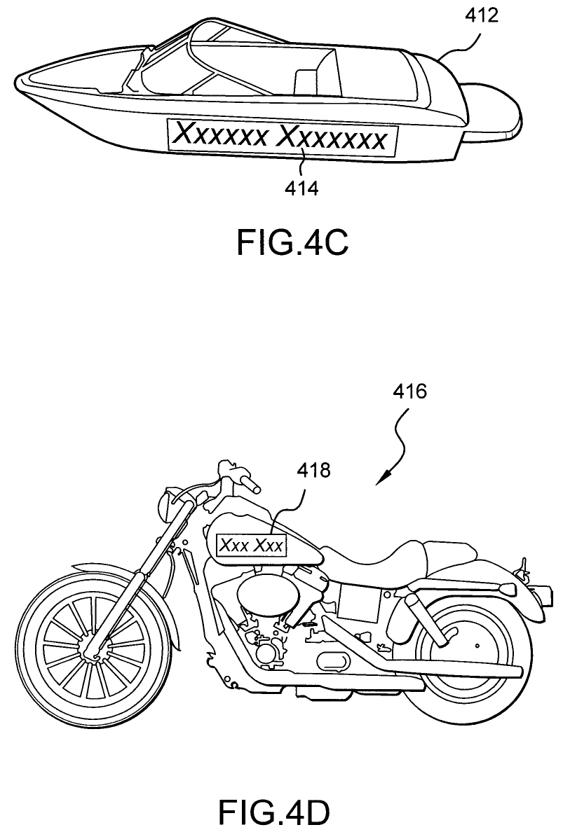

FIG. 4A shows a semi-truck and trailer as an exemplary embodiment of a printed article according to an embodiment of a printing system. Full gamut color graphics 404 and 406 as referred to in FIGS. 1A-E may be quickly applied to a semi-truck and trailer as advertisements, promotionals, or the like. If the adhesive 104 is not cured, the graphics 404 and 406 may be more easily removed and replaced by another graphic.

FIG. 4B shows an automobile as an exemplary embodiment of a printed article according to an embodiment of a printing system. A full gamut color graphic 410 as referred to in FIG. 1A-E may be applied to an automobile 408. The graphic 410 may be customized, such as a pin stripe, a racing stripe, or the like. The graphic 410 may also be an advertisement or a team logo.

FIG. 4C shows a boat as an exemplary embodiment of a printed article according to an embodiment of a printing system. A full gamut color graphic 414 as referred to in FIGS. 1A-E may be applied to a boat 412. When the boat 412 is docked, the graphic 414 can be susceptible to water, impact, abrasion, scratching, wearing, rubbing, weathering, tearing, cutting, or the like. The graphic with an overcoat 110 as described in reference to FIGS. 1A, B, and E can be tough, flexible, and resistant to impact, abrasion, scratching, cutting, tearing, or the like.

FIG. 4D shows a motorcycle as an exemplary embodiment of a printed article according to an embodiment of a printing system. A full gamut color graphic 418 as shown and described in reference to FIGS. 1A-E may be applied to a motorcycle 416. The graphic 418 may be customized. If the graphic 418 becomes damaged, out of date, or the like, the graphic 418 may be partially or fully removed without damaging the substrate 102 (see FIG. 1A-E). The graphic may be re-applied with a similar or replacement graphic.

Although embodiments for printable articles have been shown for a semi-truck and trailer 402 as in FIG. 4A, an automobile 408 as in FIG. 4B, a boat 412 as in FIG. 4C, and a motorcycle 416 as in FIG. 4D, other types of transportation equipment may also have graphics printed on them. Examples include, but are not limited to: a train, an airplane, a bicycle, a dune buggy, or a golf cart.

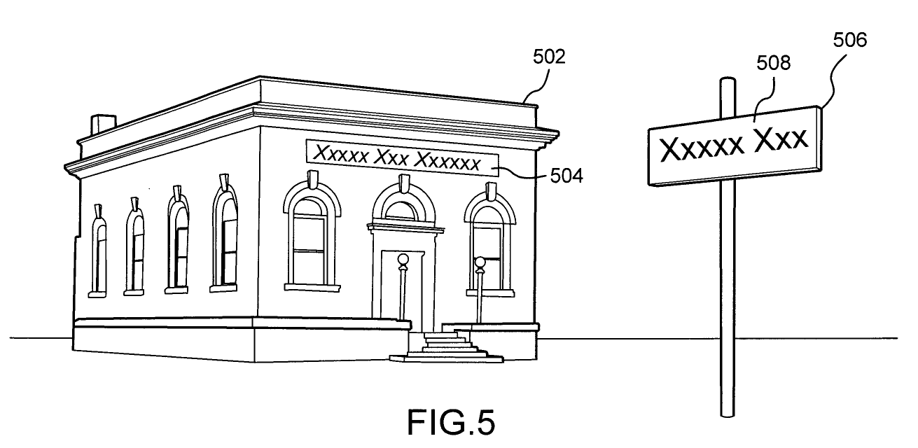

FIG. 5A illustrates signs as exemplary embodiments of printed articles according to an embodiment of a printing system. Many places of business do not have chains of stores. Chain stores may have many similarly looking signs sharing similar themes. For businesses with a limited number of stores, customized signs may be costly, since a substantial setup may increase an overall cost of the sign. However, as an alternative, a sign 506 may be produced having a customized full gamut color graphic 508 of a printed image 108 as described in reference to FIG. 1A-E. A full gamut color graphic 504 may be applied directly to a building 502. The graphic 504 may be applied to building materials such as windows for a special appearance. The appearance may be changed seasonally. Advertising and point-of-sale signs may also include a graphic 508. The graphic 508 may also be used for other types of signs, such as, but not limited to, highway signs which provide information to travelers.

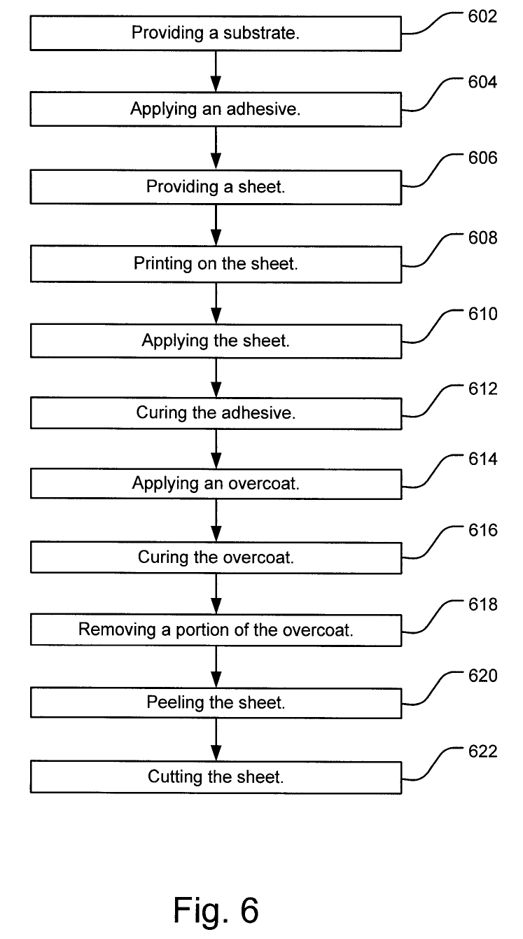

FIG. 6 shows a flowchart for applying a print to an article according to an embodiment of a printing system.

In block 602, a substrate 102 (see FIGS. 1A-E) is provided. The substrate 102 can be a surface of an article. The substrate 102 may be wood, metal, glass, plastic, brick, concrete, a fiber material such as, but not limited to, fiberglass or carbon fiber, a laminate, a polymer, or the like.

In block 604, an adhesive 104 (see FIGS. 1A-E) is applied. The adhesive may be applied to a substrate 102 or the sheet of media 106 or both. The adhesive 104 may be applied to form a continuous layer (see FIGS. 1A-E). The adhesive 104 may also be applied discontinuously and form adhesive channels 114. The adhesive 104 may be a liquid or a gel and applied by brushing, spraying, by a squeegee, ink-jet printing, gravure printing, or other methods. The adhesive 104 may also be applied as a sheet, a film, or another layer, such as, but not limited to, a self adhesive film. The self adhesive film may include a removable protection layer. The adhesive 104 may be cured by methods such as radiation, for example, thermal and UV radiation. The adhesive 104 may also remain uncured, for instance, to help allow removal of a sheet of media 106. The adhesive 104 may be cured in certain areas and uncured in other areas, for example, the adhesive 104 may be cured around a perimeter of a graphic to better protect underlying ink from environmental factors, while the adhesive 104 may be uncured in a central portion of the graphic to aid in removal of a sheet of media 106. The adhesive 104 may also be uncured or not applied to a perimeter location of the sheet of media 106 to create a tab for aiding in the removal of a sheet of media 106.

In block 606, a sheet of media 106 (see FIG. 1A-E) is provided. The sheet of media 106 may be plastic, such as, but not limited to: vinyl, a transparency film, or acetate. The sheet of media 106 may also be paper or another type of film. In FIGS. 1A and E, the sheet of media 106 may be opaque, transparent, or translucent. In FIG. 1B-D, the sheet of media 106 is substantially transparent since the printed image 108 is viewable through the sheet of media 106. The sheet of media 106 may be transparent from about 80% to 100% for the colors red, green, and blue.

In block 608, a printed image 108 is printed on a sheet of media 106. The printed image 108 may be digitally printed using a printer, for example, an ink-jet, a liquid electrophotographic, or a dry electrophotographic printer. The printed image 108 may be formed from ink—including pigmented inks, from an ink-jet printer, or the printed image 108 may be formed from toner from a dry electrophotographic printer. A liquid electrophotographic printer may use either toner or liquid ink. The printed image 108 may be a mirrored version of the printed image 108 as described in reference to block 610 below. The printed image 108 may also be transferred to the sheet of media 106 by a stamp or a press, such as, but not limited to a printing press.

In block 610, the sheet of media 106 (see FIG. 1A-E) is applied to the substrate 102. The sheet of media 106 may be aligned and pressed toward the substrate 102 using a laminator, a roller, a press, vacuum, pressure, or another method. The printed image 108 side may face up as shown in FIGS. 1A and E or the printed image side may face down as shown in FIGS. 1B-D. In FIGS. 1B-D, a mirrored version of the printed image 108 may be printed on the sheet of media 106, such that when the printed image 108 contacts the adhesive 104, the orientation of the printed image 108 is preserved when viewing the printed image 108 through the sheet of media 106. The sheet of media 106 may extend past the printed image 108 to form a border around the printed image 108 as shown in FIG. 1D. The border of the sheet of media 106 may contact the adhesive 104 to protect the printed image 108 from environmental factors such as water or the like.

In block 612, the adhesive 104 (see FIG. 1A-D) may be cured. The adhesive 104 may be thermally cured, ultraviolet cured, cured by solvent evaporation, or by other methods. Ultraviolet curing may crosslink the adhesive 104. Alternately, the adhesive 104 may remain uncured. Uncured adhesive 104 may facilitate removal of the sheet of media 106 for repair or reinstallation of a graphic, or installation of a new graphic. The adhesive 104 may be selectively cured—cured in certain areas and not in others. For example, the adhesive 104 may be cured around the side of the sheet of media 106 in FIG. 1D to protect the printed image 108 from water, moisture, chemicals, or other environmental factors, while the adhesive 104 may remain uncured near the center of the sheet of media 106 to provide easier removal.

In block 614, an overcoat 110 (see FIG. 1A-C) may be applied over the printed image 108 or sheet of media 106. The overcoat 110 may be selectively applied. For instance, the overcoat 110 may coat the entire surface of the printed image 108 or the sheet of media 106 as shown in FIG. 1A and FIG. 1B, or the overcoat 110 may coat the side of the sheet of media 106 as shown in FIG. 1C. The overcoat 110 may be a liquid or a gel, and may be applied by suitable techniques such as brushing, spraying, or using a squeegee. The overcoat 110 may also be a semi-solid film. If the overcoat 110 is a semi-solid film, the overcoat 110 may be laid over the printed image 108 or the sheet of media 106 and pressed, laminated, or the like. The overcoat 110 may be an aliphatic urethane. The printed image 108 can be visible through a relatively clear overcoat 110. In areas of the overcoat 110 where the image is visible, the overcoat 110 has a transparency from about 80% to 100% for the colors in the red, green, and blue color bands. The overcoat 110 may also be embossed with nanostructures to alter the reflection of light. The overcoat 110 may also embed unique identifiers such as holographic images and image enhancing structures such as reflective material. The overcoat may be selectively tinted or opaque in some areas to provide enhanced images, borders, or other features to the graphic.

In block 616, the overcoat 110 (see FIG. 1A-C, and E) may be cured. The overcoat 110 may be cured by solvent evaporation, thermal curing, ultraviolet curing, or other methods.

In block 618, a portion of the overcoat 110 (see FIG. 1A-C) may be removed, for example, by cutting with a sharp blade, knife, saw, or the like. A portion of the overcoat 110 or the entire overcoat 110 may be removed. Removing the overcoat 110 may facilitate repair of the graphic. Removing the overcoat can be used for adding an insert to the graphic. The graphic may be completely removed so that a new graphic may be applied.

In block 620, the sheet of media 106 (see FIG. 1A-E) may be peeled from the adhesive 104, or the sheet of media and the adhesive may be peeled from the substrate 102 or both. The sheet of media 106 may be peeled to repair a portion of the graphic or to completely remove the graphic so that a new graphic may be applied.

In block 622, the sheet of media 106 (see FIG. 1A-E) may be cut. When repairing a portion of the graphic, repair may be facilitated by cutting the sheet of media 106 so that a section of the graphic may be removed and repaired, or an insert may be placed in the graphic. The sheet of media 106 may be cut to facilitate a graphical insert.

The process described in reference to FIG. 6 provides a graphic which is shown and described in reference to FIG. 1A-E as tough, flexible, impact resistant, abrasion resistant, scratch resistant, cut resistant, wear resistant, tear resistant, water resistant, or the like. The graphic is suitable for a wide range of applications as shown and described in reference to FIGS. 2 through 5.

While the graphical embodiments have been particularly described for articles of sports, music, transportation, and signage, other articles may also be labeled, such as, but not limited to, appliances. Appliances include dishwashers, refrigerators, washing machines, dryers, televisions, computers, or the like.

While the present embodiments of a printing system have been particularly shown and described, those skilled in the art will understand that many variations may be made therein without departing from the spirit and scope of the embodiments defined in the following claims. For instance, the text and graphic may be applied to the top, bottom, and sides of a surface. The description of the embodiment is understood to include all novel and non-obvious combinations of elements described herein, and claims may be presented in this or a later application to any novel and non-obvious combination of these elements. The foregoing embodiments are illustrative, and no single feature or element would have to be included in all possible combinations that may be claimed in this or a later application. Where the claims recite “a” or “a first” element of the equivalent thereof, such claims should be understood to include incorporation of one or more such elements, neither specifically including nor excluding two or more such elements. Although exemplary embodiments of a printing system have been described, the application is not limited and may include producing a printed image 108 from a photocopier, a facsimile machine, or the like.

What is claimed is:

1. An article comprising:
a substrate;
an adhesive disposed over the substrate;
a sheet disposed over the adhesive;
a digitally printed image directly printed on the sheet; and
an elastomer disposed over the printed image.

2. The article in claim 1, further comprising an edge attached to the substrate.

3. The article in claim 2, wherein the elastomer contacts the adhesive, the substrate, and the edge.

4. The article in claim 1, wherein the adhesive or the sheet or both has one or more channels.

5. The article in claim 1, wherein the elastomer is an aliphatic elastomer.

6. The article in claim 5, wherein the aliphatic elastomer is a crosslinked aliphatic thermoplastic elastomer.

7. The article in claim 5, wherein the aliphatic elastomer is a crosslinked aliphatic polyurethane.

8. The article in claim 5, wherein the aliphatic elastomer further comprises a component selected from the group consisting of an isocyanate, a polyisocyanate, a diol, a glycol, a polyol, a polyamine, a diamine, a polyether, phenol-terminated aliphatic polyurethanes, a polyurea, a polyurea-urethane mixture and combinations thereof.

9. The article in claim 1, wherein the elastomer comprises epoxy and a weight of 10% to 80% toughener.

10. The article in claim 9, wherein the toughener is silicone.

11. The article in claim 1, wherein the elastomer has a glass transition temperature from about −40 to about −20 degrees C.

12. The article in claim 1, wherein the elastomer transmits at least 80% of light in the red, green, and blue color bands.

13. The article in claim 1, wherein the elastomer has a flexural modulus from about 200 to 500 million Pascals.

14. The article in claim 1, where the elastomer has impact resistance with a notched impact strength of at least 213 J/m.

15. The article in claim 1, where the elastomer has a cold crack resistance of −20 degrees C. and above.

16. The article in claim 1, wherein the elastomer has a Young's modulus from 20 to 500 million Pascals.

17. The article in claim 1, wherein the elastomer has cut resistance from 1 to 3.

18. The article in claim 1, wherein the elastomer has an elongation from 10% to 45% and a compression from 10% to 45%.

19. The article in claim 1, wherein the elastomer has a frictional coefficient from 0.2 to 0.6.

20. The article in claim 1, wherein the elastomer further comprises frictional filler particles, whereby the frictional filler particles tune the frictional coefficient of the elastomer.

21. The article in claim 1, wherein the printed image on the sheet is printed using one or more of ink-jet, dry electrophotographic, and liquid electrophotographic, or combinations thereof.

22. The article in claim 1, wherein the sheet is vinyl.

23. The article in claim 1, wherein the article is configured to be in contact with a person during normal operation of the article.

24. The article in claim 1, wherein the substrate is a fully formed piece of sports equipment.

25. The article in claim 1, wherein the fully formed article of sports equipment is a skateboard, a snowboard, a surfboard, a wakeboard, a bodyboard, or a ski.

26. An article comprising:
a substrate;
an adhesive disposed over the substrate;
a sheet having a surface configured to be printed on, wherein the sheet has a perimeter and a central portion, and wherein a digital image is directly printed on the central portion, and the image and the perimeter of the sheet are is in direct contact with the adhesive.

27. The article in claim 26, further comprising the sheet in contact with the adhesive.

28. The article in claim 27, further comprising an aliphatic elastomer in contact with the sheet, the adhesive and the printed image.

29. A method for printing on an article comprising:
printing on a sheet to form a printed image;
applying an adhesive to a substrate, the sheet, or both;
disposing the sheet over the adhesive; and
applying an overcoat to the sheet.

30. The method in claim 29, further comprising:
cutting the overcoat; and
peeling the sheet from the adhesive.

31. The method in claim 30, further comprising cutting the sheet.

32. The method in claim 29, wherein the sheet and the printed image is applied to the adhesive such that the printed image is opposite to the adhesive.

33. The method in claim 29, wherein the sheet and the printed image is applied to the adhesive so that the printed image is facing and contacting the adhesive.

34. The method in claim 33, wherein the printed image on the sheet forms a mirrored printed image.

35. The method in claim 29, wherein the process of applying an overcoat is selected from the group consisting of rolling, brushing, spraying, and ink-jet depositing.

36. The method in claim 35, where the process of roll coating includes gravure coating.

37. A kit for printing on an article, comprising:
a sheet for printing a printed image;
an aliphatic urethane; and
an adhesive.

38. The kit in claim 37, further comprising a silane coupling agent.
